(19) United States
(12) Patent Application Publication
(10) Pub. No.: US 2018/0319056 A1
(43) Pub. Date: Nov. 8, 2018

(54) LICE REPELLENT HAIR ACCESSORY

(71) Applicants: BURAK KUMUK, ISTANBUL (TR); DANIEL BACHRACH, GREAT NECK, NY (US)

(72) Inventors: BURAK KUMUK, ISTANBUL (TR); DANIEL BACHRACH, GREAT NECK, NY (US)

(21) Appl. No.: 15/589,487

(22) Filed: May 8, 2017

(51) Int. Cl. B29C 45/00; A45D 24/02; A45D 8/36; A45D 8/30; A45D 8/20; A45D 8/32; A45D 8/14; A01M 29/12; B29B 7/00; B29B 7/82; B29B 7/90; A01N 65/36; A01N 65/44; A01N 25/34

(52) U.S. Cl. CPC B29C 45/0001; A45D 2008/004; A45D 8/36; A45D 8/30; A45D 8/20; A45D 8/32; A45D 8/14; A01M 29/12; B29B 7/005; B29B 7/82; B29B 7/90; A01N 65/36; A01N 65/44; A01N 25/34; A45D 24/02

(57) ABSTRACT

Technologies are generally described for hair accessories and methods to make a material for repelling lice. The hair accessories may comprise a lice repellent oil infused within an injection molded plastic material. The infused injection molded plastic material may be in the shape of a hair accessory. The methods to make a material for repelling lice may comprise placing a plastic material into a mixing chamber. The methods may comprise placing a lice repellent oil into the mixing chamber. The methods may comprise mixing the plastic material and the lice repellent oil in the mixing chamber to produce an infused plastic material. The methods may comprise feeding the infused plastic material into a hopper of an injection molding machine. The methods may comprise forming the material for repelling lice by injection molding of the infused plastic material.

### BACKGROUND

Lice are small parasitic insects that are typically found on the head, scalp and hair of a human host. Lice are tiny, wingless insects that feed on blood from the scalp. Lice infestation of a human host is unpleasant.

### SUMMARY OF THE INVENTION

In one example, hair accessories are generally described. The hair accessories may comprise a lice repellent oil infused within an injection molded plastic material. The infused injection molded plastic material may be in the shape of a hair accessory.

In another example, methods to make a material for repelling lice are generally described. The methods may comprise placing a plastic material into a mixing chamber. The methods may comprise placing a lice repellent oil into the mixing chamber. The methods may comprise mixing the plastic material and the lice repellent oil in the mixing chamber to produce an infused plastic material. The methods may comprise feeding the infused plastic material into a hopper of an injection molding machine. The methods may comprise forming the material for repelling lice by injection molding of the infused plastic material.

In another example, a material for repelling lice is generally described. The material may comprise ethylene vinyl acetate (EVA). The material may comprise low-density polyethylene (LDPE). The material may comprise heliotropin. The material may comprise lemon oil. The material may comprise citronella oil.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 illustrates an example system that can be utilized to produce a lice repellent hair accessory;

FIG. 2 depicts some example configurations of lice repellent hair accessories;

FIG. 3 depicts various perspective views of a lice repellent hair accessory;

FIG. 4 depicts a flow diagram for an example process for producing a lice repellent material;

all in accordance with an embodiment of the invention.

### DETAILED DESCRIPTION

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

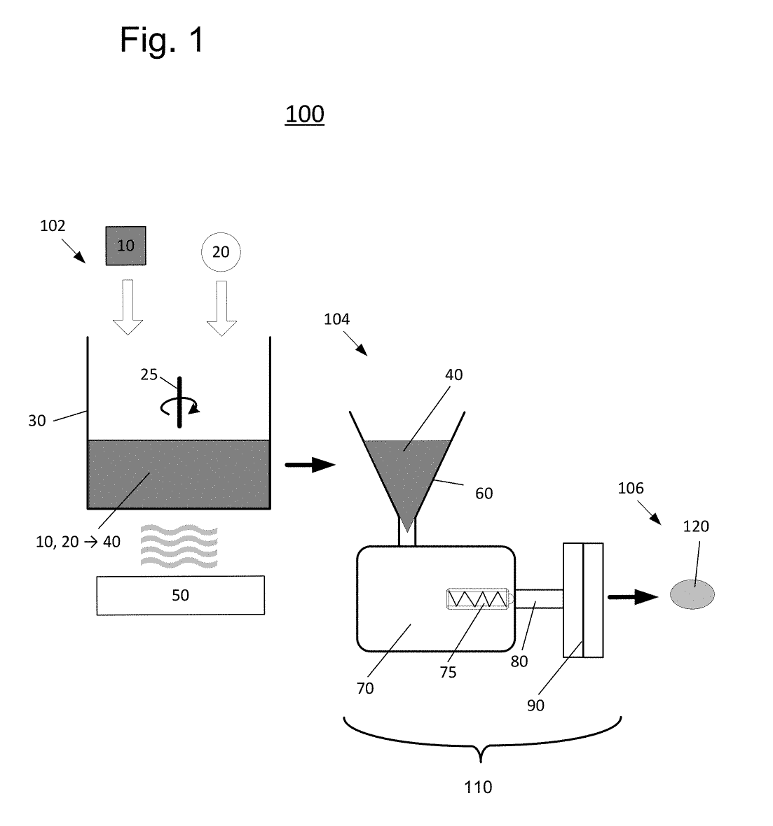

FIG. 1 illustrates an example system that can be utilized to produce a lice repellent hair accessory in accordance with at least some embodiments presented herein. System 100 may include a mixing chamber 30, a heater 50 and an injection molding machine 110. Injection mold machine 110 may include a hopper 60, a barrel 70, a nozzle 80 and a mold 90. As described in more detail below, system 100 may be utilized to produce a lice repellent hair accessory.

At 102, a material 10 and a fragrance 20 may be placed within mixing chamber 30. Material 10 may be a plastic material. Material 10 may include one or more of ethylene vinyl acetate (EVA), low-density polyethylene (LDPE), high-density polyethylene (HDPE), polypropylene (PP), polyvinyl chloride (PVC), thermoplastic elastomer (TPE), polyethylene terephthalate (PET), styrene acrylonitrile (SAN), acrylonitrile butadiene styrene (ABS), polycarbonate PC, cellulosics, and/or cellulose acetate. Material 10 may further include one or more filler materials. Filler materials included in material 10 may also act as a stabilizer. Filler materials included in material 10 may include one or more of vermiculite, calcium carbonate, sodium bicarbonate, and boric acid.

Fragrance 20 may include lice repelling oils. Fragrance 20 may include natural oils. Fragrance 20 may include one or more of heliotropin (also known as piperonal), lemon oil, rosemary oil, eucalyptus oil, tea tree oil, carrot seed oil, anise oil, mint oil, carambola oil, citronella oil, and camphor oil.

As shown in FIG. 1 at 102, material 10 and fragrance 20 may be mixed in mixing chamber 30. Mixing may be performed mechanically, such as by stirrer 25. Stirrer 25 may be operated at a speed of 10 rotations per minute to 100 rotations per minute. A heater 50 may be in thermal communication with mixing chamber 30 so as to provide heat to mixing chamber 30 during mixing of material 10 and fragrance 20. Heater 50 may supply heat sufficient to melt material 10. Heater 50 may provide heat to mixing chamber 30 to raise a temperature of mixing chamber 30 to a range from 15 degrees centigrade to 60 degrees centigrade. Mixing and heating may be performed for a time period of 2 minutes to a time period of 2880 minutes. Mixing of material 10 and fragrance 20 may produce mixture 40. Mixture 40 may include material 10 infused with fragrance 20. Mixture 40 may include one to forty mass percent fragrance 20.

At 104 mixture 40 may be feed into hopper 60 of injection molding machine 110. Gravity may guide mixture 40 from hopper 60 to barrel 70. Mixture 40 may be moved mechanically through barrel 70 to nozzle 80 and injected into mold 90 by screw-type plunger 75. Mold 90 may be at a lower temperature than mixture 40 and mixture 40 may solidify as mixture 40 fills mold 90.

At 106 solidified mixture 40 may be removed from mold 90 as molded unit 120. Molded unit 120 may be a plastic material infused with fragrance 20. Molded unit 120 may include one to forty mass percent fragrance 20.

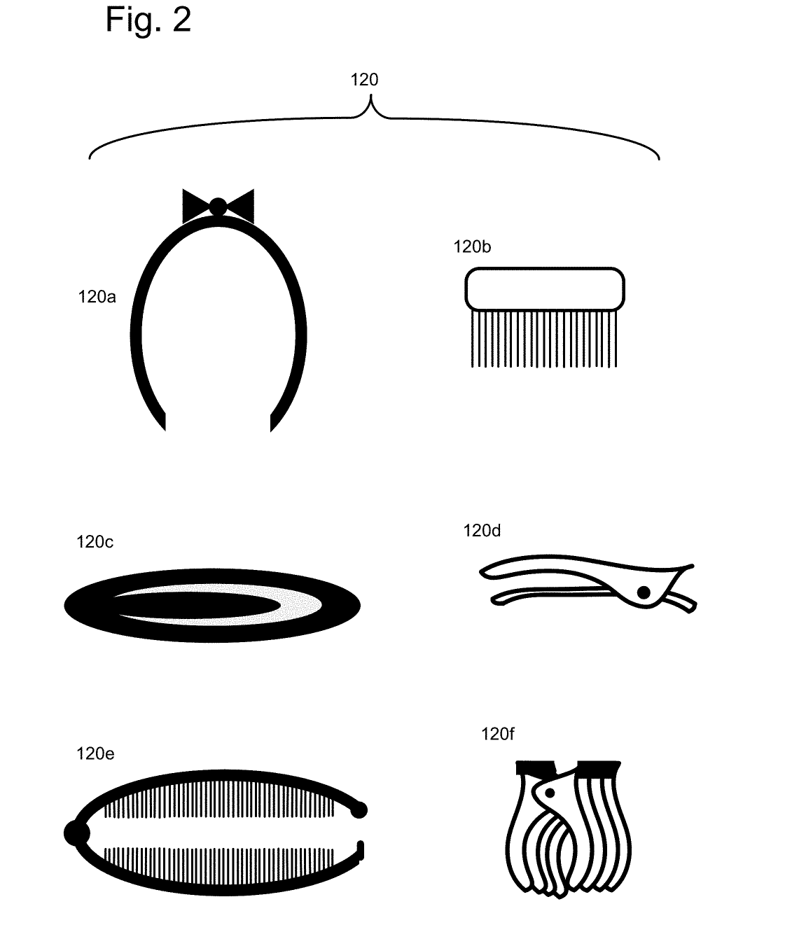

FIG. 2 illustrates various embodiments of a hair accessory in accordance with at least some embodiments presented herein. Those components in FIG. 2 that are labeled identically to components of FIG. 1 will not be described again for the purposes of clarity. Molded unit 120 may be a plastic material infused with fragrance 20 in the shape of a component, or the entirety of, a hair accessory. A hair accessory may be a functional or ornamental object that may be clipped, pinned, wrapped, tied, twisted, inserted or otherwise attached to a user's hair. Molded unit 120 may be in the shape of a component or the entirety of a hair head band 120a, a hair comb 120b, a hair clip or barrette 120c, a hair alligator clip 120d, a hair banana clip 120e, a hair claw clip 120f or any other plastic hair accessory shape. Molded unit 120 may be a component of a hair accessory, and the hair accessory may include other materials such as metals, plastics not infused with fragrance, textiles, ceramics, etc.

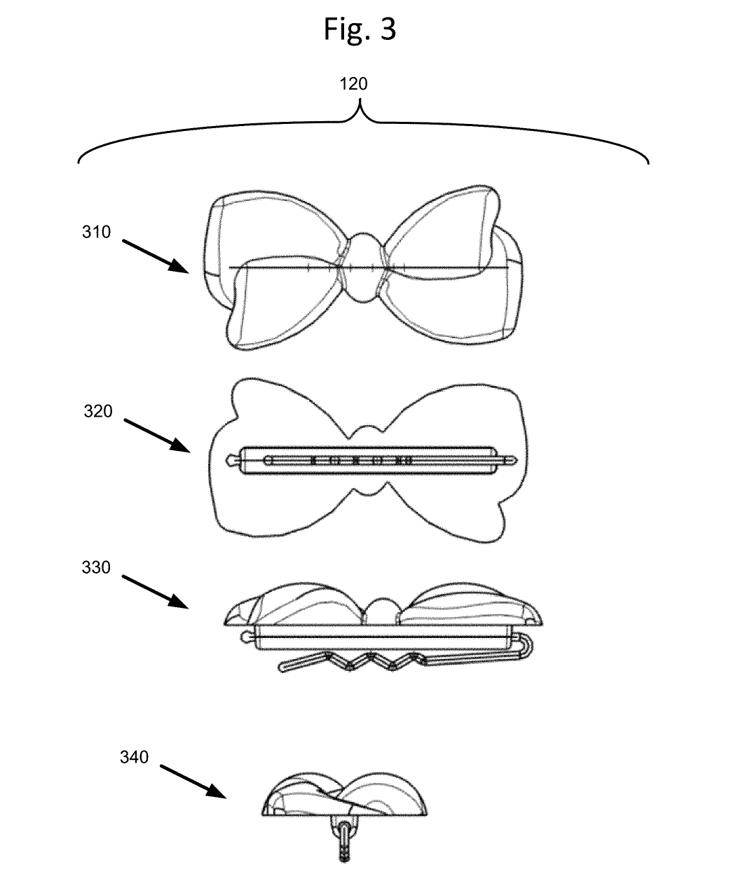

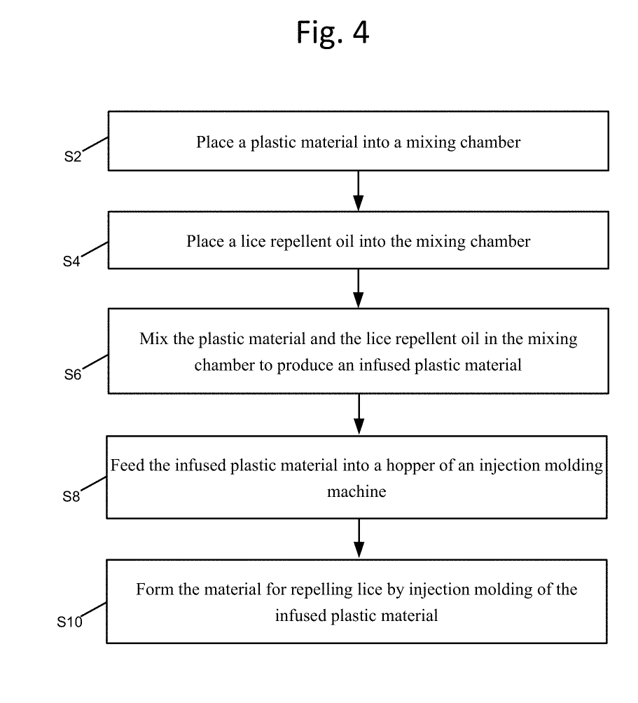

FIG. 3 depicts various perspective views of a lice repellent hair accessory in accordance with at least some embodiments presented herein. Those components in FIG. 3 that are labeled identically to components of FIGS. 1-2 will not be described again for the purposes of clarity. Molded unit 120 may be in the shape of a component, or the entirety of, a hair accessory. A hair accessory may include a top perspective 310, a bottom perspective 320, a long side perspective 330, and a short side perspective 340. FIG. 4 is a flow diagram for an example process for producing a lice repellent material in accordance with at least some embodiments presented herein. The process in FIG. 4 could be implemented using, for example, system 100 discussed above. An example process may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

Processing may begin at block S2, “Place a plastic material into a mixing chamber.” At block S2, a plastic material may be placed into a mixing chamber. The plastic material may include one or more of ethylene vinyl acetate (EVA), low-density polyethylene (LDPE), high-density polyethylene (HDPE), polypropylene (PP), polyvinyl chloride (PVC), thermoplastic elastomer (TPE), polyethylene terephthalate (PET), styrene acrylonitrile (SAN), acrylonitrile butadiene styrene (ABS), polycarbonate PC, cellulosics, and/or cellulose acetate. The plastic material may further include one or more filler materials. The filler materials may also act as a stabilizer. The filler materials may include one or more of vermiculite, calcium carbonate, sodium bicarbonate, and boric acid.

Processing may continue from block S2 to block S4, “Place a lice repellent oil into the mixing chamber.” At block S4, a lice repellent oil may be placed into the mixing chamber. The lice repellent oil may include natural oils. The lice repellent oil may include one or more of heliotropin (also known as piperonal), lemon oil, rosemary oil, eucalyptus oil, tea tree oil, carrot seed oil, anise oil, mint oil, carambola oil, citronella oil, and camphor oil.

Processing may continue from block S4 to block S6, “Mix the plastic material and the lice repellent oil in the mixing chamber to produce an infused plastic material.” At block S6, the plastic material and the lice repellent oil may be mixed in the mixing chamber to produce an oil infused plastic material. Mixing may be performed mechanically, such as by a stirrer. The stirrer may be operated at a speed of 10 rotations per minute to 100 rotations per minute. A heater may be in thermal communication with the mixing chamber so as to provide heat to the mixing chamber during mixing of the plastic material and the lice repellent oil. The heater may supply heat sufficient to melt the plastic material. The heater may provide heat to the mixing chamber to raise a temperature of the mixing chamber to a range from 15 degrees centigrade to 60 degrees centigrade. The mixing and heating may be performed for a time period of 2 minutes to a time period of 2880 minutes. The mixing of the plastic material and the lice repellent oil may produce an oil infused plastic material. The oil infused plastic material may include the plastic material infused with the lice repellent oil. The oil infused plastic material may include one to forty mass percent of the lice repellent oil.

Processing may continue from block S6 to block S8, “Feed the infused plastic material into a hopper of an injection molding machine.” At block S8, the infused plastic material may be feed into a hopper of an injection molding machine. Gravity may guide the infused plastic material from the hopper to a barrel of the injection molding machine.

Processing may continue from block S8 to block S10, “Form the material for repelling lice by injection molding of the infused plastic material.” At block S10, the infused plastic material may be injection molded to form the material for repelling lice. The infused plastic material may be may be moved mechanically through the barrel of the injection molding machine to a nozzle and injected into a mold by a screw-type plunger. The mold may be at a lower temperature than the infused plastic material, and the infused plastic material may solidify as the infused plastic material fills the mold, and form the material for repelling lice.

Among other potential benefits, an embodiment of the present application may be a hair accessory which may be worn in a user's hair to repel lice. An embodiment of the present application may provide a natural louse repellent in a fashionable hair accessory. An embodiment of the present application may provide a user with a convenient lice repellent accessory that may repel lice from head and hair of a user.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A hair accessory, the hair accessory comprising:
a lice repellent oil infused within an injection molded plastic material, wherein the infused injection molded plastic material is in the shape of a hair accessory.

2. The hair accessory of claim 1, wherein the plastic material includes one or more of ethylene vinyl acetate (EVA), low-density polyethylene (LDPE), high-density polyethylene (HDPE), polypropylene (PP), polyvinyl chloride (PVC), thermoplastic elastomer (TPE), polyethylene terephthalate (PET), styrene acrylonitrile (SAN), acrylonitrile butadiene styrene (ABS), polycarbonate (PC), cellulosics, and cellulose acetate.

3. The hair accessory of claim 1, wherein the lice repelling oil includes one or more of heliotropin, lemon oil, rosemary oil, eucalyptus oil, tea tree oil, carrot seed oil, anise oil, mint oil, carambola oil, citronella oil, and camphor oil.

4. The hair accessory of claim 1, wherein the plastic material further includes a filler material.

5. The hair accessory of claim 4, wherein the filler material is a material that acts as a stabilizer.

6. The hair accessory of claim 4, wherein the filler material includes one or more of vermiculite, calcium carbonate, sodium bicarbonate, and boric acid.

7. The hair accessory of claim 1, wherein the hair accessory is one of a hair head band, a hair comb, a hair clip, a barrette, a hair alligator clip, a hair banana clip, and a hair claw clip.

8. A method for making a material for repelling lice, the method comprising:
placing a plastic material into a mixing chamber;
placing a lice repellent oil into the mixing chamber;
mixing the plastic material and the lice repellent oil in the mixing chamber to produce an infused plastic material;
feeding the infused plastic material into a hopper of an injection molding machine; and
forming the material for repelling lice by injection molding of the infused plastic material.

9. The method of claim 8, wherein the plastic material includes one or more of ethylene vinyl acetate (EVA), low-density polyethylene (LDPE), high-density polyethylene (HDPE), polypropylene (PP), polyvinyl chloride (PVC), thermoplastic elastomer (TPE), polyethylene terephthalate (PET), styrene acrylonitrile (SAN), acrylonitrile butadiene styrene (ABS), polycarbonate PC, cellulosics, and cellulose acetate.

10. The method of claim 8, wherein the lice repelling oil includes one or more of heliotropin, lemon oil, rosemary oil, eucalyptus oil, tea tree oil, carrot seed oil, anise oil, mint oil, carambola oil, citronella oil, and camphor oil.

11. The method of claim 8, wherein the plastic material further includes a filler material.

12. The method of claim 11, wherein the filler material is a material that acts as a stabilizer.

13. The method of claim 11, wherein the filler material includes one or more of vermiculite, calcium carbonate, sodium bicarbonate, and boric acid.

14. The method of claim 8, wherein the injection molding of the infused plastic material forms the infused plastic material into a shape of a hair accessory.

15. The method of claim 14, wherein the hair accessory is one of a hair head band, a hair comb, a hair clip, a barrette, a hair alligator clip, a hair banana clip, and a hair claw clip.

16. The method of claim 8, further comprising heating the mixing chamber during the mixing of the plastic material and the lice repellent oil.

17. A material for repelling lice, the material comprising:
ethylene vinyl acetate (EVA);
low-density polyethylene (LDPE);
heliotropin;
lemon oil; and
citronella oil.

18. The material of claim 17, further comprising one or more of vermiculite, calcium carbonate, sodium bicarbonate, and boric acid.

19. The material of claim 17, wherein the material is in the shape of a hair accessory.

20. The material of claim 19, wherein the hair accessory is one of a hair head band, a hair comb, a hair clip, a barrette, a hair alligator clip, a hair banana clip, and a hair claw clip.
